(19) United States
(12) Patent Application Publication
(10) Pub. No.: US 2009/0109236 A1
(43) Pub. Date: Apr. 30, 2009

(54) LOCALIZED COLOR TRANSFER

(75) Inventors: Ying-Qing Xu, Beijing (CN); Fang Wen, Beijing (CN); Qing Luan, Xian (CN); Lin Liang, Beijing (CN)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/193,970

(22) Filed: Aug. 19, 2008

Related U.S. Application Data
(60) Provisional application No. 60/983,860, filed on Oct. 30, 2007.

(51) Int. Cl. G09G 5/02

(52) U.S. Cl. 345/589

(57) ABSTRACT

Techniques for providing localized color transfer are disclosed. In some aspects, a user may select a source region of a source image and a destination region of a destination image. The source region and the destination region may be associated by a designator to create a color transfer pair. A localized color transfer based on the color style of the source region may be implemented to modify the destination region color style. Further aspects may include optimizing the destination image to reduce discontinuities resulting from the color transfer and enabling the user to select regions of the destination image which are not modified by localized color transfer.

### RELATED APPLICATIONS

This application claims priority to U.S. Provisional Patent Application No. 60/983,860 to Ying-Qing Xu et al., entitled, “Color Transfer Brush”, filed Oct. 30, 2007 and incorporated herein by reference.

### BACKGROUND

Manipulation of graphic imagery is often desirable to enhance image appearance, modify an image to meet specific requirements, or for other reasons. In many situations, it is more practical to attain a desired image by modifying an existing image rather than to create a new image without the benefit of the existing image. For example, it is often impractical and sometimes impossible for a photographer to return to a location where a photograph was taken to retake the photograph with different photographic attributes, such as lighting.

Digital imagery has continued to evolve to enable modification of images. Some digital imagery tools enable users to change some aspects of colorization of an image. In some situations, a reference color may be available from a second image. A user may desire to transfer the color, or colorization, from the first image to the second image. Color transfer operations are useful features in graphic imaging because the example image provides a good preview of the final effect on a destination image. Some algorithms have been introduced to provide automatic global color transfer. These algorithms may perform well in transferring global color styles, but they are often inflexible and do not enable a user to specify many aspects of the color transfer.

In addition, current color transfer tools are typically not intuitive and are difficult to use. For example, many color transfer tools require knowledge of complex toolkits and take large amounts of time to make relatively small changes to an image.

### SUMMARY

This summary is provided to introduce simplified concepts of localized color transfer between one or more source images and a destination image, which is further described below in the Detailed Description. This summary is not intended to identify essential features of the claimed subject matter, nor is it intended for use in determining the scope of the claimed subject matter.

Exemplary techniques for providing localized color transfer are disclosed. According to one or more embodiments, a source region of a source image and a destination region of a destination image are selected based on user input. The source region and the destination region may be linked or otherwise associated by a designator to create a color transfer pair. The color style of the source region is used to modify the color style of the destination region.

In some embodiments, an optimization process may be used to remove any resulting discontinuities that may remain after the destination region is modified. Further embodiments may include receiving a selection of a maintain region by a user. The maintain region may be designated to not receive color style information from the source region and/or to be modified by the optimization process.

In still further embodiments, additional source regions may be selected by the user, including source regions from additional source images. The additional source regions may be used to create additional color transfer pairs, which in turn may facilitate localized color transfer to the destination image.

### BRIEF DESCRIPTION OF THE DRAWINGS

The detailed description is described with reference to the accompanying figures. In the figures, the left-most digit(s) of a reference number identifies the figure in which the reference number first appears. The same reference number in different figures refers to similar or identical items.

FIG. 1 shows an illustrative environment that may be used to implement localized color transfer techniques in accordance with one or more embodiments of localized color transfer.

FIG. 2 shows an illustrative pictorial flow diagram of selectively transferring color information using a localized color transfer tool in accordance with embodiments of localized color transfer.

FIG. 3 shows an illustrative flow diagram of using the localized color transfer tool in accordance with another embodiment of localized color transfer.

FIG. 4 shows illustrative imagery by which image color data from multiple source images is used to selectively modify a destination image in accordance with yet another embodiment of localized color transfer.

FIG. 5 shows an illustrative pictorial flow diagram of selectively maintaining color information using a color maintain tool in accordance with embodiments of localized color transfer.

FIG. 6 shows an illustrative flow diagram of using the color maintain tool in accordance with another embodiment of localized color transfer.

FIG. 7 shows an illustrative example created by using the localized color transfer tool and the color maintain tool to modify a destination image in accordance with still another embodiment of localized color transfer.

FIG. 8 shows a block diagram of an illustrative computing device which may be part of the environment show in FIG. 1.

### DETAILED DESCRIPTION

### Illustrative Environment

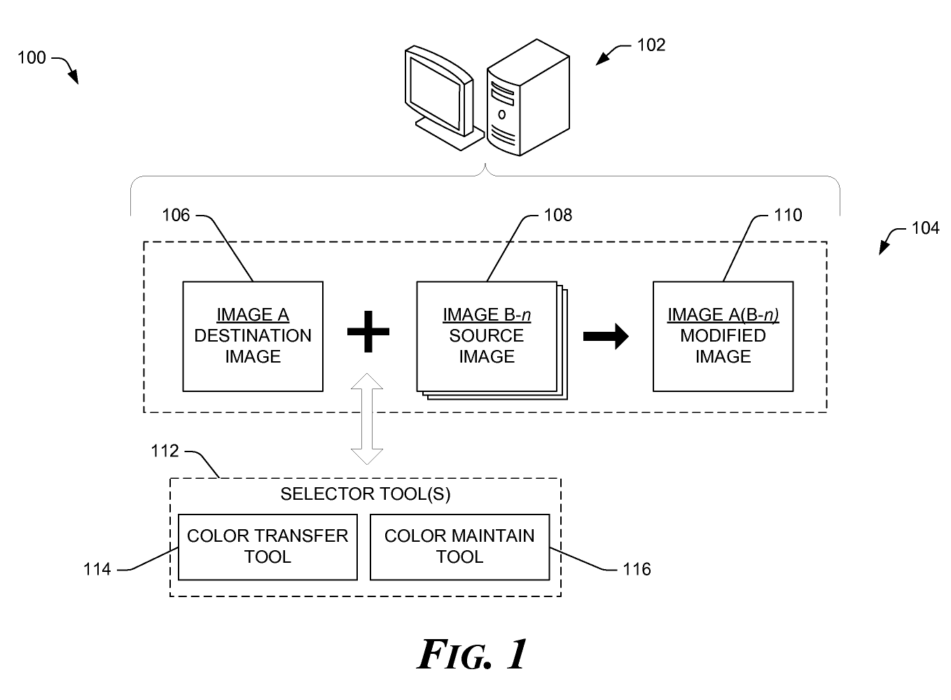

FIG. 1 shows an illustrative environment 100 that may be used to implement localized color transfer techniques in accordance with one or more embodiments of localized color transfer. The environment 100 includes at least a computing device 102 and a localized color transfer component 104. The computing device 102 may be a personal computer, a laptop computer, a server, a camera, a camcorder, a portable digital assistant (PDA), a mobile phone, a game console, or any other device capable of storing, processing, and modifying digital images.

In accordance with one or more embodiments, the localized color transfer component 104 includes a destination image 106 and one or more source images 108. The destination image 106 is any image a user desires to modify using the techniques described herein. For example, the destination image 106 may be a digital photography image, a scanned image, or an image obtained using other techniques to create a digital image. The destination image 106 and the source images 108 may be stored using any type of available image storage format or compression scheme, including without limitations, .jpeg, .bmp, .gif, .png, .eps, .psd, and so forth.

The source images 108 are images which contain color styles based on color statistics, which the user desires to transfer in part to the destination image 106. For example, the source images 108 may be a collection of images in a digital library, scanned images, downloaded images (e.g., obtained from the Internet or another network repository), and so forth, or a collection thereof. The user may select one or more of the sources images 108 based on specific colorization regions of the source images, which the user desires to transfer to the destination image 106.

The localized color transfer techniques, as described herein, enable the user to modify the destination image 106 with colorization from the source images 108 to create a modified image 110. The user may map user-selected regions of the source images 108 to user-selected regions of the destination image 106 to facilitate the localized color transfer techniques. User mapping addresses the problem of establishing regional correspondence in a localized color transfer process. Thus, the user may edit the color style of the destination image 106 based on color styles included in the source images 108. The color style of the destination image 106 may be progressively modified by transferring desirable color statistics from user-selected source region(s) of the source images 108 to the destination region(s) of the destination image 106 that are specified by the user with a designed color transfer tool 112.

In some embodiments, the localized color transfer component 104 may include one or more selector tools 112 to facilitate mapping region of the source images 108 and destination images 106, or to otherwise select, demarcate, or identify regions in the source images or the destination images. The selector tools 112 may include a color transfer tool 114 and/or a color maintain tool 116. The color transfer tool 114 to enable users to select regions of images for color transfer. The color maintain tool 116 may enable users to select regions of images to maintain the color of those regions. The color transfer tool 114 and/or the color maintain tool 116 may be such as, and without limitation, a brush, sprayer, free-form sketcher, shape tool, or other selection tool.

The localized color transfer techniques described herein enable direct and local control of modifications to the destination image 106. The localized color transfer techniques may enable a transfer of color distributions to produce rich color variations in the modified image 110, which are not limited to single color variations or a single source image.

### Illustrative Localized Color Transfer

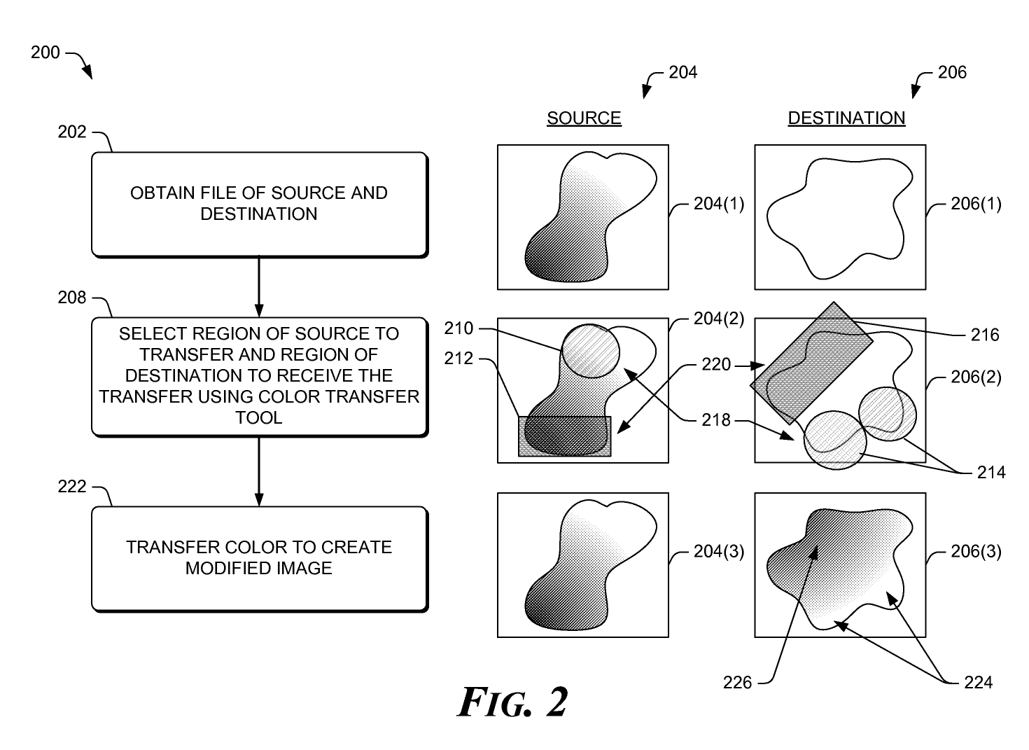

FIG. 2 shows an illustrative pictorial flow diagram of a process 200 of selectively transferring color information in accordance with embodiments of localized color transfer. The process 200 is illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 200, shall be interpreted accordingly.

As shown in FIG. 2, at 202, the computing device 102 may obtain one or more source files and a destination file. For example, a user may cause the computing device 102 to open various image files, including the one or more source files corresponding to the one or more source images 204 and the destination file corresponding to a destination image 206. At the operation 202, a source image 204(1) and a destination image 206(1) are obtained by the computing device 102, such as being caused to be loaded into memory of the computing device.

In some embodiments, at 208, the user may select a region of a source image 204(2) having a color style to transfer to a region of the destination image 206. For example, the source image 204(2) may include a first selected source region 210 and a second selected source region 212, which correspond to a first selected destination region 214 and a second selected destination region 216, respectively.

The selected source and destination regions may include designators to associate a selected region of the source image 204(2) to a selected region of the destination image 206(2) to create a color transfer pair. For example, a first designator 218 may associate the first selected source region 210 to the first selected destination region 214 to create a first color transfer pair. Similarly, a second designator 220 may associate the second selected source region 212 to the second selected destination region 216 to create a second color transfer pair. Although two color transfer pairs are shown at the operation 208, any number of color transfer pairs may be created including a single color transfer pair. The designators for each color transfer pair may be unique designators which are distinguishable and differentiated by attributes such as a color, pattern, shape, or other type of designator attribute.

At 222, a color style, including color statistic information, may be transferred, at least in part, from a source image 204(3) to the destination image 206 to create a modified image 206(3). The modified image 206(3) may include modified regions 224, 226, which include colorization statistics from the first selected source region 210 and the second selected source region 212, respectively.

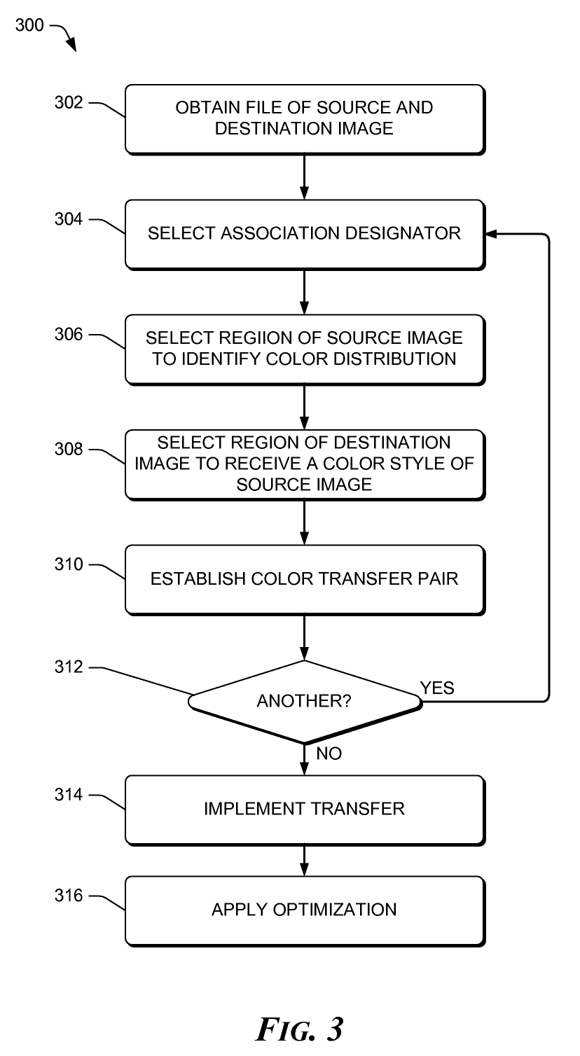

FIG. 3 shows an illustrative flow diagram of a process 300 of localized color transfer in accordance with another embodiment. At 302, the computing device 102 may obtain files for the source image(s) 108 and the destination image 106.

In accordance with one or more embodiments, at 304, the user may select a designator (e.g., designator 218, 220) to associate a source region with a destination region. A unique designator may be used for each color transfer pair. The designator may be a color, a pattern, a shape (e.g., a circular shape, polygon, etc.), or other type of designator which associates the source region and the designation region. For example, a green color designator may be selected by the user. The user may then use the green color designator, via the selector tools 112, such as the color transfer tool 114 or other selector tool, and identify a source region and a destination region, which will be associated as a color transfer pair because they share the same green color designator. In some embodiments, the designator may be automatically selected for a user when the user attempts to create a color transfer pair. Additionally or alternatively, the designator may be selectable by the user.

At 306, the user selects a region of the source image. The selection may be made with the color transfer tool 114 of FIG. 1, such as a brush or other selector. For example, the user may make a brush stroke across an area in a freeform motion to select a region. The user may also make a selection by covering a region of the source image with the designator to select a region. In some embodiments, the region may be determined by parts of the source image which are covered by the user selection, while in additional embodiments, the region may be demarcated by the region inside a boundary established by the user. In some embodiments, the color transfer tool 114 may include user modifiable attributes, such as a brush size, line thickness, and so forth to enable the user to more effectively select the source region at 306 or in other selection processes described herein.

At 308, the user selects a region of the destination image to receive a color style of the source image. The selection may be made with the same designator as used for the source region selection at the operation 306, thus associating the source region and selected destination region as a color transfer pair. In some embodiments, the user may select more than one region of the destination image to be associated to the source region. Thus, a one-to-many relationship may exist between source regions and destination regions. The selection of the source region and the destination region makes color transfer an intuitive and controllable task by enabling users to locally determine color transfer regions

In accordance with some embodiments, the operations 306, 308 may include a boundary identification function to enable a user to select a region that is identifiable in an image. For example, boundaries may be established in an image based on changes in colorization, linear patterns, or other features which create visual and/or intuitive boundaries in an image. When the user selects a source region (via the operation 306) or a destination region (via the operation 308), the selected region may be increased or decreased to snap (i.e., align) to a boundary of the image. In some embodiments, the user may override a snap to boundary function.

In some embodiments, the user may modify the selected source regions and/or destination regions. For example, the user may delete selected regions, modify the boundaries by adding or subtracting from the regions, or take other actions to modify the regions.

At 310, a color transfer pair is established for the designator selected at the operation 304 for the selected source region and the selected destination region(s). For example, when a user selects a source region and a destination region with the same designator, the color transfer pair may be automatically formed at the operation 310.

At 312, the user may optionally select additional region transfer pairs using the operations 304-310.

At 314, the user may implement the color transfer when the user is finished associating regions of the source image with regions of the destination image.

In accordance with some embodiments, the localized color transfer of color statistics from the source region to the destination region of a color transfer pair may be implemented in part using techniques discussed in Reinhard et al. (E. Reinhard, M. Ashikhmin, B. Gooch, and P. Shirley, “Color Transfer Between Images,” IEEE, Computer Graphics and Applications, vol. 21, p. 34-41, 2001., hereinafter “Reinhard”). Reinhard includes an effective automatic color transfer method for global transfer of color statistics and relies on Equation 1, as follows.

$$g ( {C}_{d} ) = {μ}_{s} + \frac{{θ}_{s}}{{θ}_{d}} ( {C}_{d} - {μ}_{d} ) \qquad Equation 1$$

In Equation 1, μₛ, μ_{d} are the means of the underlying Gaussian distribution in the source and destination images and θₛ, θ_{d} are the standard deviations, respectively. Thus, for each pixel with color C_{d} in the destination image, the transferred color value g(C_{d}) is obtained using equation 1. Lab color space, without limitation, may be used in the algorithm of Equation 1.

In accordance with some embodiments, at the operation 314, the localized color transfer is implemented by using Equation 1 to apply local color style transfer to the transfer region pairs. For Equation 1 to be successful, similarity must be present in the image composition and the simplicity of image statistics of the source region and the destination region. The implementation of Equation 1 may be complementary to transfer a localized color style to a color transfer pair, which is interactively defined by the user because the user intuitively selects regions that are similar in content. For example, a user may select a sky as a source region to transfer a sunset color style to a destination region that is also a sky. It follows that the source and destination regions are likely to have similar color statistics. When transfer takes place in local regions, the color statistics involved are comparatively simpler than the entire image. Thus, color transfer using equation 1 may consistently perform well in local regions that are selected by users.

At 316, the computing device 102 may perform an optimization to the destination image after the color transfer has been completed in the operation 314. The localized color transfer of the operation 314 may result in discontinuity across the destination image, such as between the region that has the color transfer and an adjacent region of the image. A global optimization (or simply “optimization”) process may be used to remove at least a portion of any resulting discontinuity in the destination image. The optimization may be used to eliminate the discontinuity on the transfer region boundary as well as maintain the gradient in the rest of the destination image. Based on a known boundary between regions, the optimization stage may enhance the cross-region coherence by naturally propagating the colors beyond the boundaries while preserving the gradient of the remaining parts of the destination image. To perform the optimization, Equation 2 may be used, where the energy term is minimized.

$$E = {\sum }_{< p , q > ⋂ Ω \neq 0} {( {u}_{pq} - {v}_{pq} )}^{2} \qquad Equation 2$$

In Equation 2, μ_{pq}=ƒₚ−_{q}, where f is the unknown function for the optimization and v_{pq}=gₚ−g_{q}, where g is the value of original image. In addition, p and q are neighbor pixels and Ω represents the regions that are not covered by the transfer process of the operation 314. On the boundary of the region, ƒₚ=gₚ.

Equation 2 may form a sparse, symmetric, positive-definite system. In an embodiment, a Gauss-Seidel SOR algorithm (Y. Saad, “Iterative Methods For Sparse Linear Systems,” 1 st Ed. PWS, 1996.) may be used to minimize the energy in Equation 2 because the Gauss-Seidel SOR algorithm has a stable performance. In some embodiments, the optimization resembles that in Poisson image editing because both techniques aim to maintain a gradient that maintains salient features for visual quality as discussed in Perez et al. (P. Perez, M. Gangnet, and A. Blake, “Poisson Image Editing,” ACM Transaction on Graphics, vol. 22, p. 313-318, 2003.)

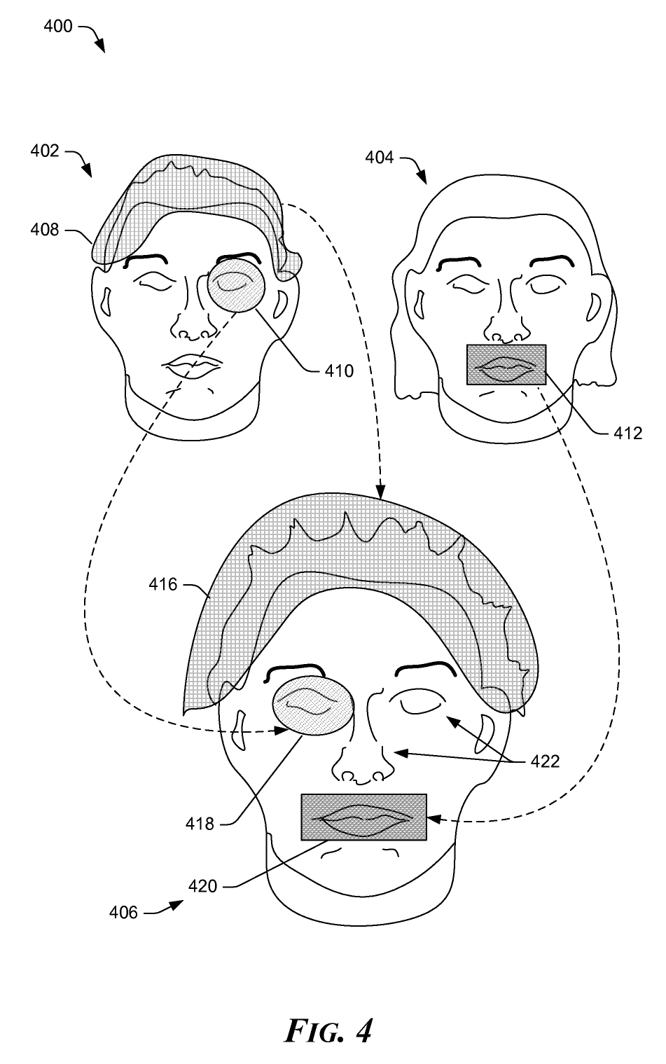

FIG. 4 shows illustrative imagery 400, where localized image color data from multiple source images is used to selectively modify a destination image in accordance with yet another embodiment of localized color transfer. The imagery 400 shows one possible use of the localized color transfer techniques described herein. For example, the localized color transfer techniques may be used to show a simulated result of an application of makeup to demonstrate various cosmetic effects a person may desire. With the color transfer tool 114 of FIG. 1, the user may virtually apply various makeup styles from a plurality of source images, such as a first source image 402 and second source image 404, to modify a destination image 406, such as an image of the user. For example, a customized application may include many samples of images which may include the source images 402, 404, having various makeup applications. The user may upload the destination image 406, which may be an image of the user, or another image which may receive the color styles of the source images. The user may virtually sample a portion of the various makeup applications by using the color transfer tool 114 to transfer color styles from the source image to the destination image to simulate a makeup application.

In some embodiments, a first source region 408 may be selected using the color transfer tool 114, such as a brush tool, to demarcate the region of the first source image 402 that shows the color of a person's hair in the first source image 402. The user may select the first source region 408 by dragging the brush tool over the hair portion of the first source image until the hair is completely covered by the designator. In some embodiments, other color transfer tools may be used to select source regions and/or destinations, such as a line tool, object tool, and so forth. Some color transfer tools may enable selecting the region inside of an area demarcated by the user while other color transfer tools may be used to select an area covered by an application of the tool, such as brush strokes over the region. Similarly, the user may select a second source region 410 from the first source image. In addition, the user optionally may select a color style from other source images, such as the second source image 404. Thus, the user may select a third source region 412.

The user may select corresponding regions on the destination image 406 which are associated with the source regions 408, 410, 412 via unique designators which create color transfer pairs. As shown in the imagery 400, three color transfer pairs are established. A first color transfer pair includes the first source region 408 and a first destination region 416. A second color transfer pair includes the second source region 410 and a second destination region 418. A third color transfer pair includes the third source region 412 and a third destination region 420.

As shown in FIG. 4, the source region may not be identical in size, shape, or another attributes as the destination region. Additionally, the region of a source image may not align with the same region of the destination image, such as the first source region 408 being the left eye of a person being associated with the first destination region 416, being the right eye. Finally, non-selected areas 422 of the destination image may remain substantially unchanged after the color transfer process 300. For example, the non-selected areas 422 may not be changed based on the color transfer implementation of the operation 314 but may be slightly modified during the optimization of the operation 316.

### Illustrative Localized Color Transfer and Color Maintain

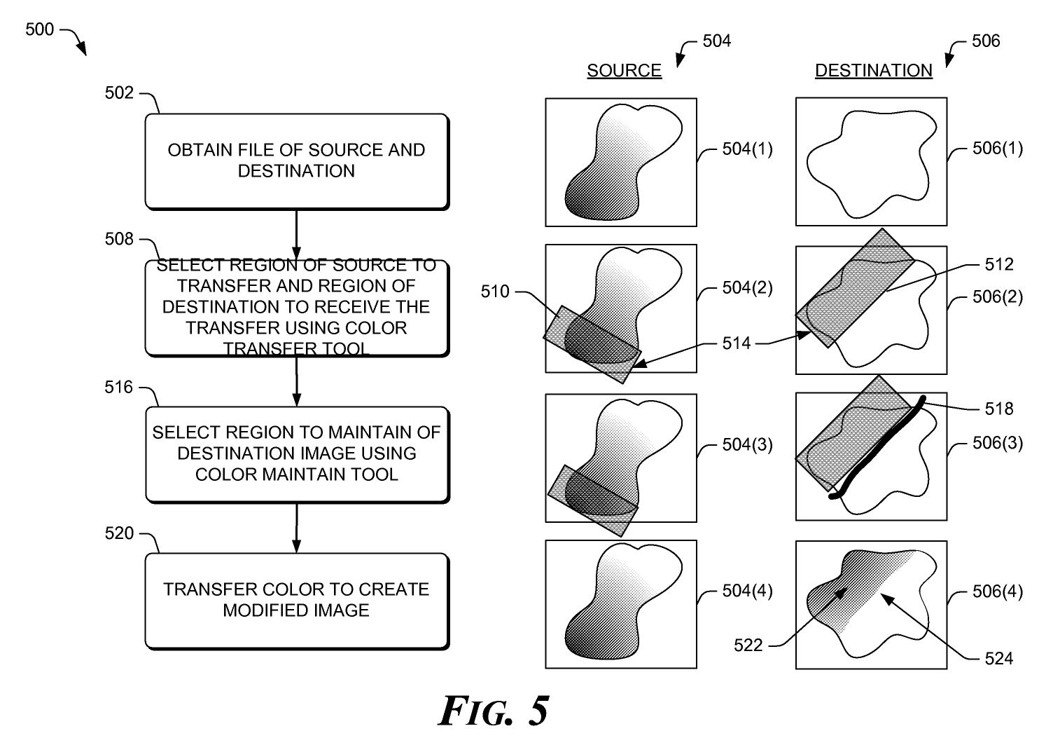

FIG. 5 shows an illustrative pictorial flow diagram of a process 500 of selectively maintaining color information in accordance with embodiments of localized color transfer. At 502, the computing device 102 may obtain one or more source images 504, such as a source image 504(1), and a destination file 506, such as a destination image 506(1). At 508, the user may select a source region 510 of the source image 504(2) having a color style to transfer to a destination region 512 of the destination image 506(2).

In accordance with one or more embodiments, at 516, the user may select a region where the user desires the color of the destination image 506(3) to be maintained, rather than to be modified by a transferred color style from the source image 504(3). The user may select a maintain region 518 by a demarcation line, area, or by other user selections. For example, a maintain region 518 may be established by the user drawing a line between a selected destination region, such as the destination region 512 and another portion of the destination image 506(3). In other embodiments, the maintain region may be determined by a user selection of an entire area to maintain, such as by using the color maintain tool 116 of FIG. 1 (e.g., a brush, sprayer, free-form sketcher, etc.) to cover an entire region of the destination image that the user desires to maintain. The maintain region 518 may include a unique designator such as a color, pattern, shape, and so forth, which enables a user to identify the maintain region 518.

At 520, the color style may be transferred from the source image 504(4) to the destination image 506 to create a modified image 506(4). The modified image 506(4) may include modified regions 522, which include colorization statistics from the selected source region 510. In addition, the modified image 506(4) may include a color maintained region 524, which is maintained because of the maintain region 518, and thus not altered by the color transfer process.

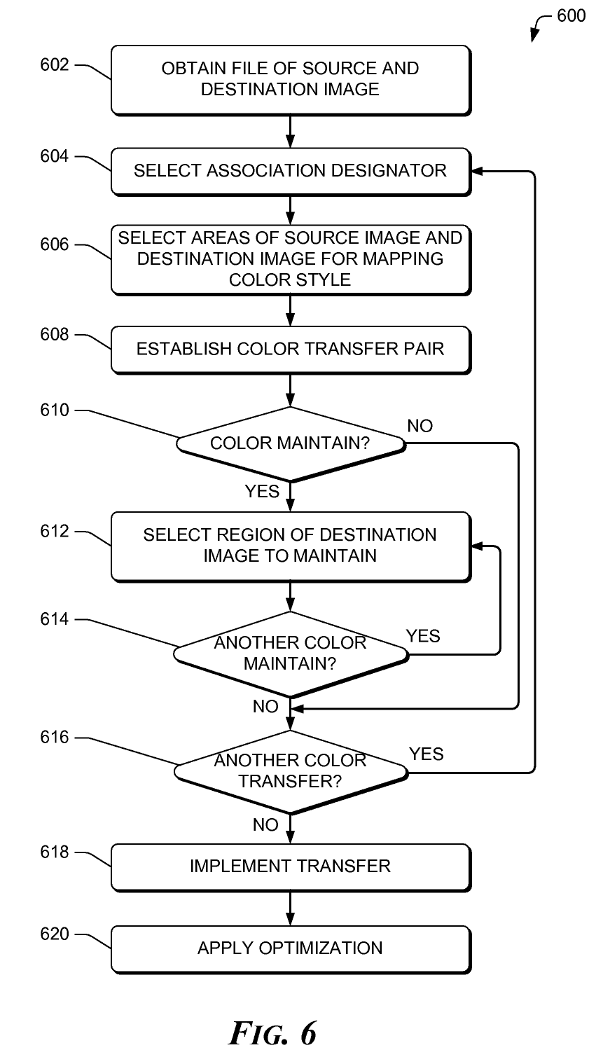

FIG. 6 shows an illustrative flow diagram of a process 600 of using the color maintain tool 116 in accordance with another embodiment of localized color transfer. At 602, the computing device 102 may obtain files for the source image(s) 108 and the destination image 106 of FIG. 1. At 604, the user may select a designator to associate a source region with one or more destination regions. At 606, the user may select the source region and the destination region. At 608, a color transfer pair is established for the designator selected at the operation 604 for the selected source region and the selected destination region(s).

In accordance with one or more embodiments, at 610, the user may demarcate one or more destination regions as maintain regions with the color maintain tool 116 to maintain a color style of the maintain regions in the destination image after a localized color transfer process is implemented for other regions of the destination image. When the user desires to create a maintain region, at 612, the user selects a region of the destination image to maintain. In some embodiments, the user may draw a boundary across a portion of the image to create the maintain region while in other embodiments the user may select the maintain region by circumscribing the maintain region or covering the maintain region, such as by covering it with brush strokes by the color maintain tool 116. At 614, the user may create an additional color maintain region. At 616, the user may select another color transfer by returning to the operation 604.

In accordance with some embodiments, the color transfer may be implemented by the computing device at 618. The color transfer at 618 is similar to the color transfer that was described at the operation 314 of FIG. 3. When color maintain regions are established by the user, the color transfer process may not affect the maintain regions. For example, the user may create a color maintain region inside of a color transfer region. In such an instance, the maintain region may not be modified after the operation 618. In further embodiments, it is contemplated that editing functions may be implemented to remove color transfer regions and/or color maintain regions before the implementation of the color transfer at the operation 618.

In some embodiments, at 620, the computing device may perform an optimization to the destination image after the color transfer has been completed in the operation 618. The optimization at 620 is similar to the optimization that was described at the operation 316 of FIG. 3. In some embodiments, the maintain regions may not be modified by the optimization. For example, any discontinuity across the image, such as between the region(s) that have the color transfer and the maintain region(s) of the image may be maintained after the optimization at 620. In other embodiments, the maintain region may only maintain a color style of the maintain region during the color transfer implementation of the operation 618. In some embodiments, the user may selectively control which processes may modify the maintain regions, such as the operation 618 and/or the operation 620. Using both the color transfer tool 114 and color maintain tool 116 discussed above, the user may experience enhanced ability to control the final result of an image modification.

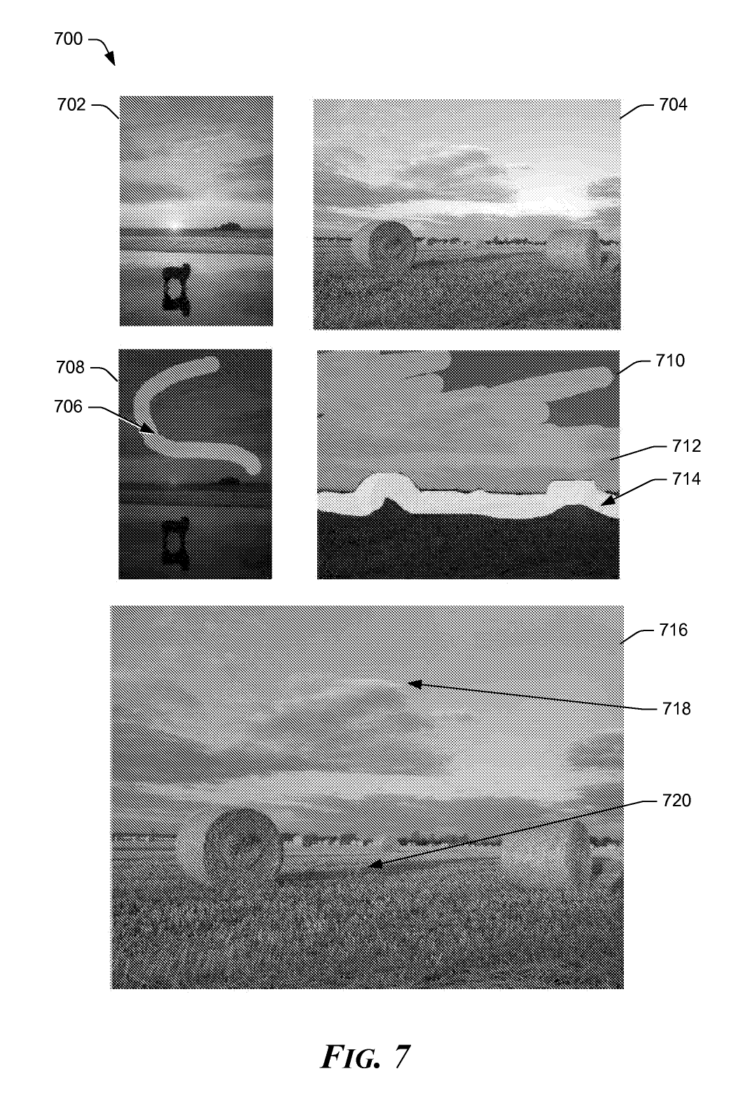

FIG. 7 shows an illustrative imagery 700 created by the localized color transfer tool 114 and the color maintain tool 116 to modify a destination image in accordance with still another embodiment of localized color transfer. A source image 702 and a destination image 704 may be loaded into memory in the computing device 102.

In accordance with one or more embodiments, the user may select a source region 706 on a selected source image 708. For example, the user may brush a line over an area of the sky represented in the selected source image 708. In some embodiments, the selected source image 708 may change in shade (e.g., get darker or lighter) to show that a source region has been selected and/or the user is in a localized color transfer mode. A selected destination image 710 may include a user selected destination region 712. For example, the user may use the color maintain tool 116, such as a brush, to cover a portion of the sky representation of the destination image 710. The user may also create a maintain region 714. The maintain region 714 may be a line drawn adjacent to the destination region, such that the color transfer does not occur beyond the maintain region 714.

A modified image 716 may be created from the destination image after a localized color transfer and optimization, including a color maintain process. As shown, a first region 718 representing the sky of the modified image 716 shows the new color style reflecting the color style of the source region 706, as applied to the destination region 712. A second region 720 may include the original image color style because of the presence and operation of the maintain region 714.

In further embodiments, the localized color transfer techniques herein may be used to obtain much richer colors for a color transfer process than previously available. For example, stroke-based colorization often looks flat and unnatural because only a limited number of strokes are used. Instead of carefully specifying multiple colors, the color transfer techniques disclosed herein enable the user to select one or more source regions from a plurality of source images to apply to a destination image to make a modified image include richer color variation than would otherwise be attainable.

### Exemplary System

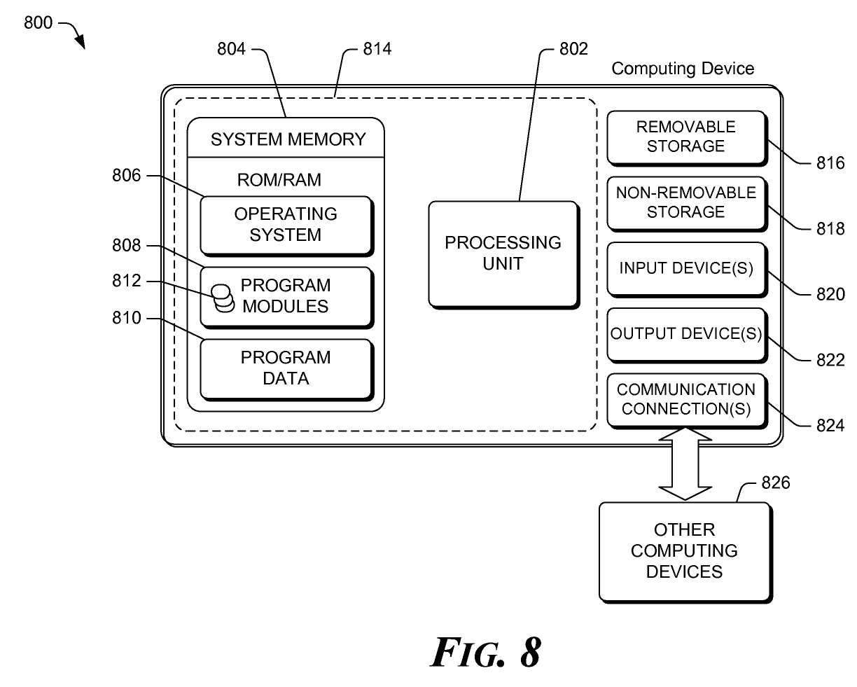

FIG. 8 shows a block diagram of an illustrative computing device 800 which may be part of the environment show in FIG. 1. In a very basic configuration, computing device 800 typically includes at least one processing unit 802 and system memory 804. Depending on the exact configuration and type of computing device, system memory 804 may be volatile (such as RAM), non-volatile (such as ROM, flash memory, etc.) or some combination of the two. System memory 804 typically includes an operating system 806, one or more program modules 808, and may include program data 810. The program modules 808 may include one or more components 812 for implementing the localized color transfer techniques as described herein. For example, the program modules 808 may include, without limitation, a color transfer module and a color maintain module in addition to a color transfer module and an optimization module. This basic configuration is illustrated in FIG. 8 by those components within dashed line 814.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by removable storage 816 and non-removable storage 818. Computer storage media may include volatile and nonvolatile, removable and non-removable media implemented in any method or technology for storage of information, such as computer readable instructions, data structures, program modules, or other data. System memory 804, removable storage 816 and non-removable storage 818 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media may be part of device 800. Computing device 800 may also have input device(s) 820 such as keyboard, mouse, pen, voice input device, touch input device, etc. Output device(s) 822 such as a display, speakers, printer, etc. may also be included. These devices are well known in the art and need not be discussed at length here.

Computing device 800 may also contain communication connections 824 that allow the device to communicate with other computing devices 826, such as over a network. Communication connection(s) 824 is one example of communication media. By way of example, and not limitation, communication media includes wired media such as a wired network or direct-wired connection, and wireless media such as acoustic, RF, infrared and other wireless media. Computer readable media can be any available media that can be accessed by a computer. By way of example, and not limitation, computer readable media may comprise “computer storage media” and “communications media.”

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. These program modules and the like may be executed as native code or may be downloaded and executed, such as in a virtual machine or other just-in-time compilation execution environment. Typically, the functionality of the program modules may be combined or distributed as desired in various embodiments. An implementation of these modules and techniques may be stored on or transmitted across some form of computer readable media.

### Conclusion

The above-described techniques (e.g., methods, systems, etc.) pertain to localized color transfer techniques. Although the techniques have been described in language specific to structural features and/or methodological acts, it is to be understood that the appended claims are not necessarily limited to the specific features or acts described. Rather, the specific features and acts are disclosed as exemplary forms of implementing such techniques.

What is claimed is:

1. A method of providing localized color transfer to an image, the method comprising:
obtaining a plurality source images and a destination image from a storage media;
receiving a user selection of a source region of a source image of the plurality source images and a user selection of a destination region of the destination image, the source region and the destination region being associated as a transfer color pair;
modifying color statistics of the destination region based on color statistics of the source region; and
applying a optimization to the destination image to reduce at least a portion of any visual discontinuities resulting from the modified color statistics of the designated region.

2. The method of claim 1, wherein the transfer color pair includes a transfer designator to associate the source region to the destination region.

3. The method of claim 2, wherein the transfer designator is a color associated with a color transfer tool configured for use to select the source region and the destination region.

4. The method of claim 1, further comprising receiving a user selection of a maintain region of the destination image, the maintain region having a boundary where a first side of the boundary is designated to maintain the color statistics of the destination image and a second side of the boundary is designated to receive the color statistics of the source region.

5. The method of claim 4, wherein the transfer color pair includes a transfer designator to associate the source region to the destination region, and wherein the maintain region includes a maintain designator that is distinguishable from the transfer designator.

6. The method of claim 1, further comprising storing the destination image in a tangible medium.

7. The method of claim 1, wherein the modifying color statistics of the destination region includes transferring color statistics using a localized Gaussian distribution for pixel colorization in the source region and the destination region.

8. One or more computer readable media comprising computer-executable instructions that, when executed by a computer, perform acts comprising:
receiving a source region from a first user input, the source region associated with a source image and having a designator;
receiving a destination region from a second user input, the destination region associated with a destination image and having the designator;
creating a color transfer pair by associating the source region and the destination region by the designator; and
transferring color statistic information of the color transfer pair from the source region to the destination region.

9. One or more computer readable media as in claim 8, further comprising receiving a maintain region from a third user input, the maintain region associated with the destination image.

10. One or more computer readable media as in claim 9, wherein the maintain region is protected from modification by the transferring color statistic information.

11. One or more computer readable media as in claim 8, further comprising reducing discontinuity resulting from the transferring the color statistic information by applying an optimization to at least a portion of the destination image.

12. One or more computer readable media as in claim 8, wherein the designator is selectable by the user.

13. One or more computer readable media as in claim 8, wherein the designator is visually discernable by the user and associates the source region with the destination region.

14. One or more computer readable media as in claim 8, further comprising creating a second color transfer pair by:
receiving a second source region from at least one of the source image or a second source image, the second source region having a second designator; and
receiving a second destination region associated with the destination image having the second designator; and
associating the second source region to the second destination region by the second designator.

15. A color transfer method, comprising:
obtaining a source image and a destination image, the source image including a color style that a user desires to transfer to a region of the destination image;
receiving a user selected mapping of a source region having a source color style to a destination region having a destination color style;
modifying the destination color style of the destination region based on the source color style from the source region; and
applying an optimization to at least a portion of the destination image to reduce a discontinuity resulting from the modifying the destination color style.

16. The method of claim 15, wherein the user selected mapping includes a designator to associate the source region to the destination region.

17. The method of claim 16, wherein the designator is at least one of a color, a pattern, or a shape.

18. The method of claim 15, wherein the modifying the destination color style includes modifying color statistics of the destination region based on color statistics of the selected regions to adjust a color distribution of at least a portion of the destination region.

19. The method of claim 15, further comprising receiving a second user selection to demarcate a second region of the destination region as a maintain color region which is not modified based on at least one of the source color style from the source region or the optimization.

20. The method of claim 15, wherein the applying the optimization includes enhancing the cross-region coherence of the destination image by propagating the colors beyond boundaries of the destination region while preserving the gradient of the destination image.
